(19) United States
(12) Patent Application Publication
(10) Pub. No.: US 2017/0249829 A1
(43) Pub. Date: Aug. 31, 2017

(54) Alarm System with Projection Means

(71) Applicant: Thomas P. Brady, Collierville, TN (US)

(72) Inventor: Thomas P. Brady, Collierville, TN (US)

(21) Appl. No.: 15/056,729

(22) Filed: Feb. 29, 2016

(51) Int. Cl. G08B 25/00; G08B 5/22; G08B 27/00; G08B 26/00

(52) U.S. Cl. CPC G08B 25/006; G08B 26/008; G08B 5/22; G08B 27/003

(57) ABSTRACT

An alarm system with a plurality of projection means located on the outside of the structure or structures the alarm system is monitoring that are integrated into the alarm system so that the plurality of projection means may display an image when the alarm system has not been tripped and displays an appropriate image associated with the type of incident that tripped the alarm when the alarm has been tripped.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC

Not Applicable

### DESCRIPTION

### FIELD OF THE INVENTION

This disclosure relates residential and commercial alarms system whereby a projection means is incorporated into the alarm system to project items such as an alarm company logo, an alert message, video recorded by the alarm system of the recent break-in, or a map of the property indicating relevant features.

### BACKGROUND OF THE INVENTION

Traditional alarm systems are used in commercial, industrial, governmental, and residential settings as a means of monitoring a physical structure or structures in order to generate an alert if the status of the physical structure or structure changes and comprise a control unit, a means of communication, sensors, and an alarm. The control unit is the brains of the alarm system. The means of communication allow a user to interact with the control unit to activate, deactivate, monitor, and program the alarm system and include connections to a computer, where the user can use a keyboard, computer mouse or touch screen to interact with the alarm system, a touch pad or key pad directly connected to the control unit, or remote access methods through a connection between the control unit and the internet or phone system such as through a remote computer or cell phone. The sensors monitor the structure or structures and trip the system to set off the alarm of the system and comprise such as video cameras, motion detectors, contact sensors, glass breakage detectors, and heat sensors. The alarm is the method the alarm system uses to send a notification that the alarm has been tripped or activated and comprises notification methods such as a horn that blares in the immediate vicinity, and sends out alerts through the telephone system or internet. Traditional alarm systems are now also integrated into the household systems such as the heating and air conditioning, lighting, electrical appliances, and electronics and allow the user of the system to control these household systems through the alarm system.

Traditional alarm systems use items such as placards or window stickers to advertise that a property has an alarm system and the name and contact information of the alarm service company. These placards and stickers are intended to assist in deterring break-in, however, they are frequently used by competing alarm service companies to determine what alarm system is in use so that a bid can be sent to the occupant in an effort to undercut competition and take over the alarm service contract. In addition, in the event the alarm system is tripped, the common practice in the industry is to send an alert to the alarm service company, the police, or set off a horn. The present disclosure reveals a plurality of projection means such as video projectors, video monitors, or holographic projectors located on the exterior of the property that are integrated into the alarm system with the use of an integration circuit and associated logic that allows the plurality of projection means to work with the traditional alarm system in order to project an image such as an alarm company logo or video selected by the user when the alarm system has not been tripped or an appropriate image such as an alert message, video recorded by the alarm system immediately prior to the alarm being tripped, a map of the structure or structures indicating relevant features, or other information when the alarm system has been tripped.

### SUMMARY OF THE INVENTION

The present disclosure reveals an alarm system where in addition to the traditional alarm the alarm system comprises a plurality of projection means on the exterior of the of the property, wherein projection means includes video projectors, video monitors, or holographic projectors, wherein the projection means can be hard wired to the alarm system control unit or remotely accessed by the alarm system control unit, and wherein the alarm system control unit is capable of being programmed to present displays through the projection means. Such displays can include such images, either continuously or at designated times, as the ability to display the logo of the alarm service company, holiday or special occasion designs, programmed messages or video, alert notices regarding a break-in and whom to contact, video stored in the alarm system control unit, or a map of the structure or structures.

In one embodiment of the logic the plurality of projection means are off when the alarm system has not been tripped but when the alarm system has been tripped, the plurality of projection means are activated to display an appropriate image depending on the reason why the alarm system was tripped. In this instance, if there is more than one projection means in the plurality of projection means, each projection means in the plurality of projection means could be programmed to present different appropriate images. The appropriate image presented may be static images or video.

In a second embodiment of the logic, the plurality of projection means can be programmed to display an image, either continuously or at desired time periods when the system has not been tripped and when the alarm system has been tripped, the plurality of projection means display an appropriate image depending on the reason why the alarm system was tripped. In this instance, if there are more than one projection means in the plurality of projection means, each projection means in the plurality of projection means could be programmed to display a different image when the alarm system has not been tripped and each projection means in the plurality of projection means could be programmed to display a different appropriate image when the system has been tripped. The displayed image or appropriate image presented may be static images or video.

In a third embodiment of the logic, the plurality of projection means can be programmed to display an image, either continuously or at desired time periods when the system has not been tripped but when the alarm system has been tripped, the plurality of projection means display appropriate images captured during an interval prior to the alarm system being tripped. In this instance, if there are more than one projection means in the plurality of projection means, each projection means in the plurality of projection means could be programmed to present different images when the alarm system has not been tripped and each projection means in the plurality of projection means could be programmed to present different appropriate images when the system has been tripped. The images or appropriate images presented may be static or video.

### BRIEF DESCRIPTION OF THE SEVERAL VIEWS OF THE DRAWING

FIG. 1 is a pictorial of the alarm system with a traditional alarm system and a plurality of projection means on the exterior of the residence, wherein the plurality of projection means are hard-wired into the alarm system;

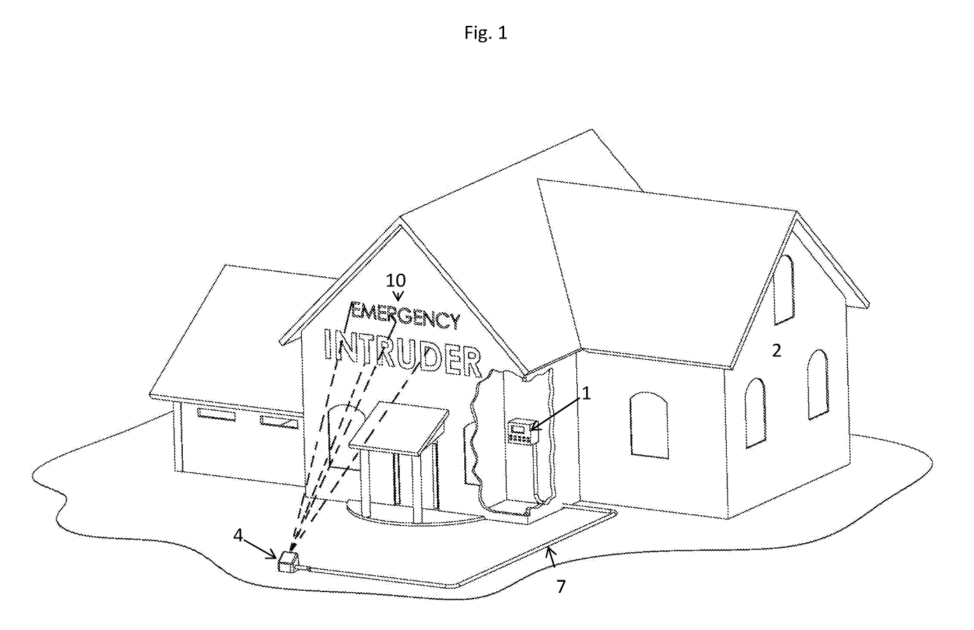

FIG. 2 is a pictorial of the alarm system with a traditional alarm system and a plurality of projection means on the exterior of the residence, wherein the alarm system accesses the plurality of projection means wirelessly;

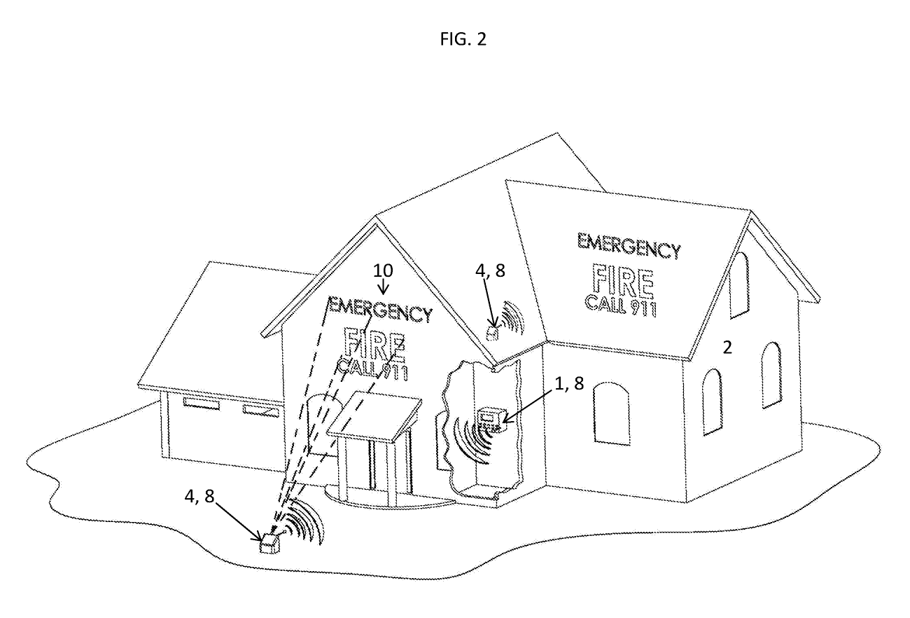

FIG. 3 is a pictorial of the traditional alarm system with the integrated circuit for the plurality of projection means;

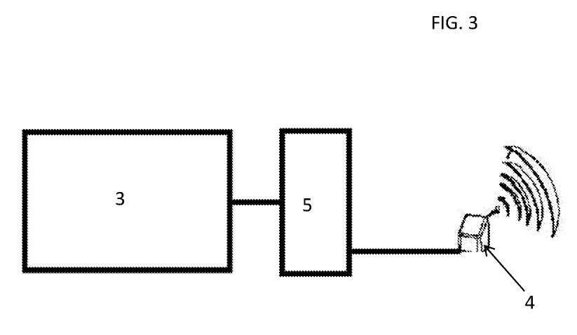

FIG. 4 is a logic diagram of the logic of for the first embodiment of the alarm system where each projection means is presenting the same appropriate image;

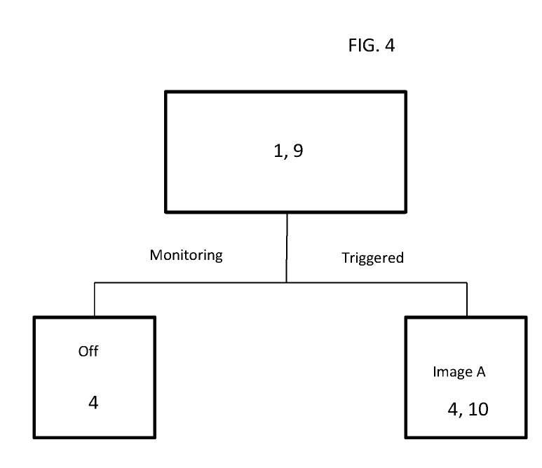

FIG. 5 is a logic diagram of the logic of for the first embodiment of the alarm system where the plurality of projection means can display different appropriate images;

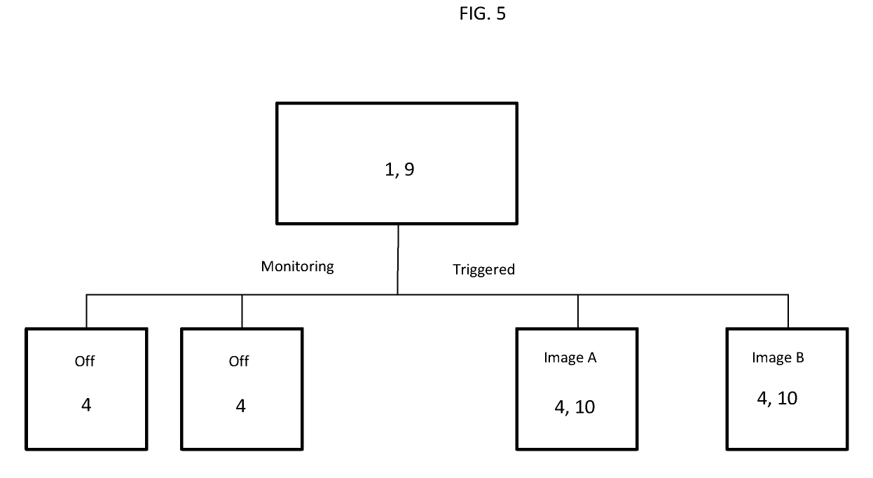

FIG. 6 is a logic diagram of the logic of for the second embodiment of the alarm system where each projection means is presenting the same image or appropriate image;

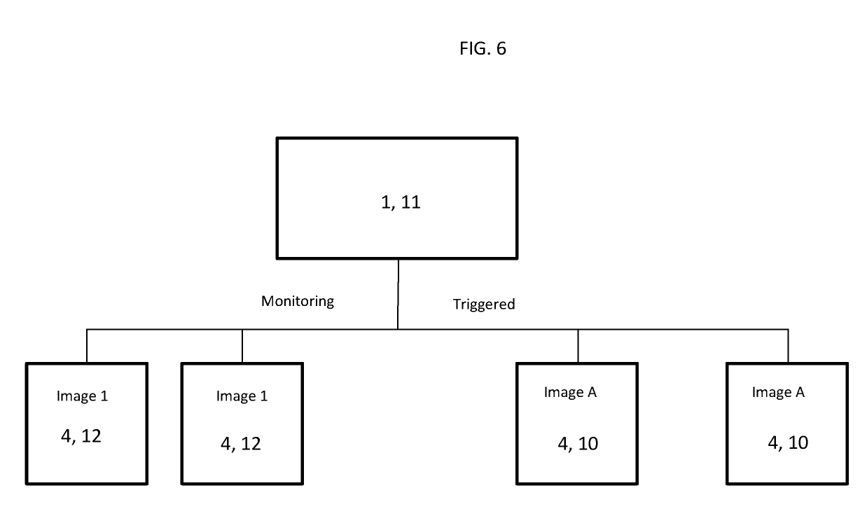

FIG. 7 is a logic diagram of the logic of for the second embodiment of the alarm system where the plurality of projection means can display different images or appropriate images;

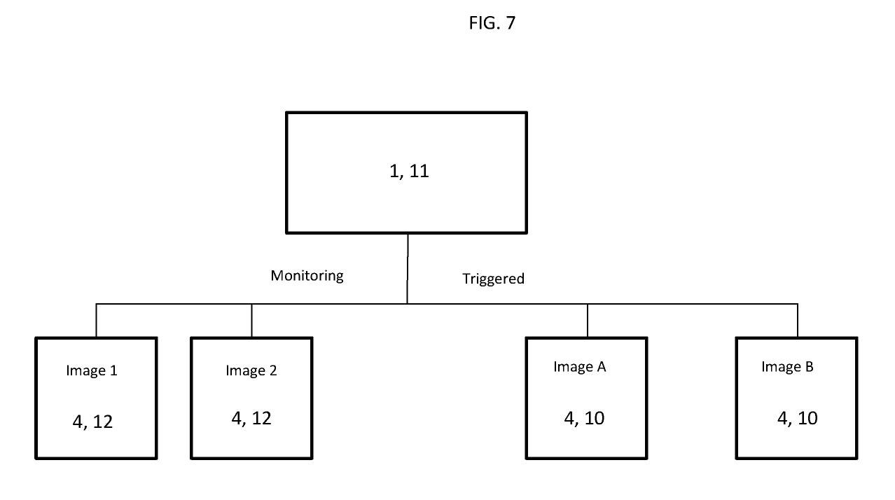

FIG. 8 is a logic diagram of the logic of for the third embodiment of the alarm system where each projection means is presenting the same image or appropriate image; and

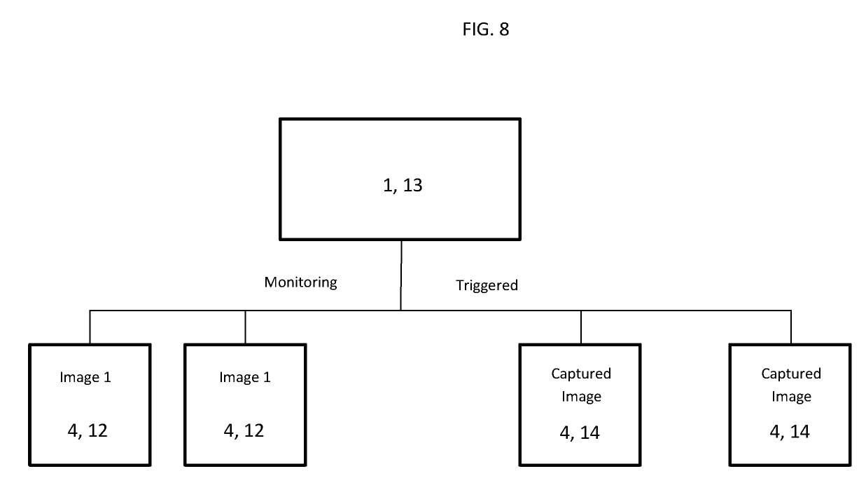

FIG. 9 is a logic diagram of the logic of for the third embodiment of the alarm system where the plurality of projection means can display different images or appropriate images.

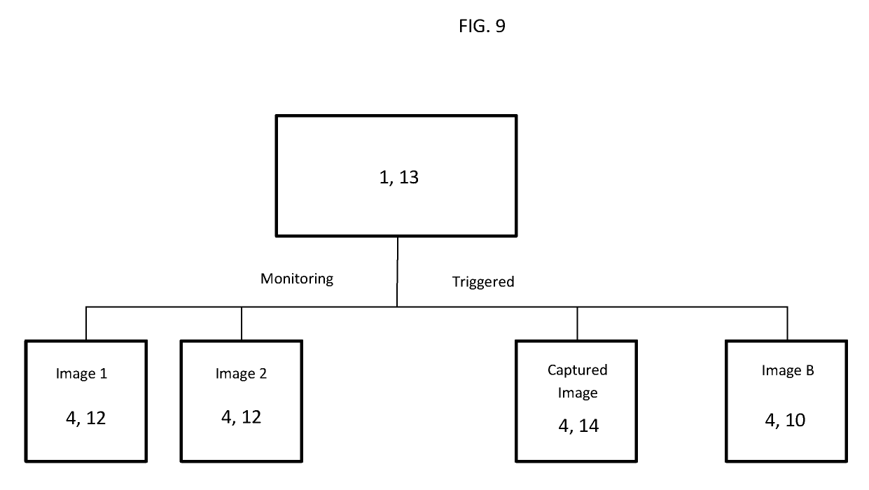

### DETAILED DESCRIPTION OF THE INVENTION

The present disclosure reveals an alarm system 1 for monitoring a structure or structures 2 comprising the components of a traditional alarm system 3 as well as a plurality of projection means 4 on the exterior of the structure or structures 2 being monitored, the integrated circuit 5 and the logic 6 necessary to integrate the plurality of projection means 4 into the traditional alarm system 3. The plurality of projection means 4 can be either hard-wired 7 into the alarm system 1 or the alarm system 1 can access the plurality of projection means 4 wirelessly 8.

In the first embodiment 9 of the alarm system the plurality of projection means 4 are off when the alarm system 1 has not been tripped but display an appropriate image 10 associated with the type of incident that tripped the alarm system 1 when the alarm system 1 has been tripped. In this embodiment, it may be possible that each of the plurality of projection means 4 can display a different appropriate image 10.

In the second embodiment 11 of the alarm system the plurality of projection means can display an image 12 when the alarm system 1 has not been tripped but display an appropriate image 10 associated with the type of incident that tripped the alarm system 1 when the alarm system 1 has been tripped. In this embodiment, it may be possible that each of the plurality of projection means 4 can display a different appropriate image 10.

In the third embodiment 13 of the alarm system 1 the plurality of projection means 4 can display an image 12 when the alarm system has not been tripped but display an appropriate image 10 associated with the type of incident that tripped that alarm system 1 when the alarm system 1 has been tripped and that appropriate image 10 may be of video recorded 14 by the alarm system 1 during an interval prior to the alarm system 1 being tripped. In this embodiment, it may be possible that each of the plurality of projection means 4 can display a different appropriate image 10.

What is claimed:

1. (canceled)

2. (canceled)

3. (canceled)

4. (canceled)

5. An alarm system for monitoring a structure or structures comprising:
the components of a traditional alarm system as well as a plurality of projection means on an exterior of the structure or structures being monitored, an integrated circuit and logic necessary to integrate the plurality of projection means into the traditional alarm system;
wherein the plurality of projection means is hard-wired into the alarm system; and
wherein, when the alarm system has not been tripped, the plurality of projection means displays at least one of no image or an image, but the plurality of projection means displays an appropriate image associated with the type of incident that tripped that alarm system when the alarm system has been tripped.

6. The alarm system of claim 5 wherein each of the plurality of projection means displays at least one of the same appropriate image or different appropriate images.

7. The alarm system of claim 5 wherein, when the alarm system has not been tripped, the plurality of projection means displays at least one of no image or an image, but displays an appropriate image associated with the type of incident that tripped that alarm system when the alarm system has been tripped and that image is of video recorded by the alarm system during an interval prior to the alarm system being tripped.

8. The alarm system of claim 7 wherein each of the plurality of projection means displays at least one of the same appropriate image or different appropriate images.

9. (canceled)

10. (canceled)

11. (canceled)

12. An alarm system for monitoring a structure or structures comprising:
the components of a traditional alarm system as well as a plurality of projection means on an exterior of the structure or structures being monitored, an integrated circuit and logic necessary to integrate the plurality of projection means into the traditional alarm system;
wherein the plurality of projection means can be wirelessly accessed by the alarm system; and
wherein, when the alarm system has not been tripped, the plurality of projection means displays at least one of no image or an image, but the plurality of projection means displays an appropriate image associated with the type of incident that tripped that alarm system when the alarm system has been tripped.

13. The alarm system of claim 12 wherein each of the plurality of projection means displays at least one of the same appropriate image or different appropriate images.

14. The alarm system of claim 12 wherein, when the alarm system has not been tripped the plurality of projection means displays at least one of no image or an image, but displays an appropriate image associated with the type of incident that tripped that alarm system when the alarm system has been tripped and that image is of video recorded by the alarm system during an interval prior to the alarm system being tripped.

15. The alarm system of claim 14 wherein each of the plurality of projection means displays at least one of the same appropriate image or different appropriate images.
